(19) United States
(12) Patent Application Publication
(10) Pub. No.: US 2004/0190832 A1
(43) Pub. Date: Sep. 30, 2004

(54) Optical coupling unit

(75) Inventors: Peter Brockhaus, Berlin (DE); Thomas Knuth, Berlin (DE)

Correspondence Address: BEVER HOFFMAN & HARMS, LLP, TRI-VALLEY OFFICE, 1432 CONCANNON BLVD., BLDG. G, LIVERMORE, CA, 94550, US

(73) Assignee: Infineon Technologies AG, Munich (DE)

(21) Appl. No.: 10/772,615

(22) Filed: Feb. 4, 2004

(30) Foreign Application Priority Data
Mar. 27, 2003 (DE) 10314495.1

(51) Int. Cl. G02B 6/30; G02B 6/26

(52) U.S. Cl. 385/49; 385/47

(57) ABSTRACT

An optical coupling unit for the coupling of at least one optoelectronic converter to an assigned optical waveguide. The coupling unit includes a monolithic glass block in which at least one integrated light guiding channel is produced by changing the refractive index of the glass material using laser irradiation. The glass block has at least one reflection surface, at which light signals are deflected between a light receiving surface and a light transmitting surface. The coupling unit provides a simple configuration including few components, can be produced by means of an automated production process and can be variably adapted to the given circumstances.

### FIELD OF THE INVENTION

The invention relates to an optical coupling unit and to an arrangement for the coupling of light signals with such a coupling unit.

### BACKGROUND OF THE INVENTION

In WO 98/38539 A2 there is a description of an electrical coupling assembly which substantially comprises two substrates. The first substrate aligns a number of optical waveguides, the coupling-side end surfaces of which cause a beam deflection to a multichannel converter. This converter is carried and precisely positioned by the second substrate, so that optically active surfaces of the converter are coupled to the coupling-side end surfaces of the optical waveguides. The first and second substrates have corresponding oblique surfaces, which effect a form-locking engagement for the adjustment of the end surfaces of the optical waveguides with respect to the optically active surfaces of the converter.

The known coupling assembly disadvantageously comprises many individual parts, that is specifically two substrates, a number of fibers and securing pins. The putting together of these many components proves to be complicated; in particular, the fibers must be threaded in and adhesively fixed. Further disadvantages are that assembly cannot be automated and the plane in which the light is coupled out is not variable but fixed in advance by the form of the substrates.

It is known from the article by K. Minoshima et al.: ‘fabrication of coupled mode photonic devices in glass by nonlinear femtosecond laser materials processing’, OPTICS EXPRESS 645, Vol. 10, No. 15, to use ultrashort laser pulses which have light outputs in the megawatt range to partially change the structure of glasses by supplying a large amount of energy. This leads to a change in the refractive index. The refractive index is higher in the regions newly melted by supplying energy. This is used in the article to make the modes of parallel optical lines which are formed in a block by aforementioned laser pulses interact with one another.

### SUMMARY OF THE INVENTION

The invention is directed to an optical coupling unit which comprises few components, can be produced by means of an automated production process and can be variably adapted to the given circumstances. It is also intended to provide an optical arrangement which, using such a coupling unit, provides light coupling between an optoelectronic converter and an assigned optical waveguide.

According to the invention, it is accordingly provided that the coupling unit has a monolithic glass block. This represents the connecting link between one or more optoelectronic converters and one or more optical waveguides. In this case, a deflection of the received or emitted light takes place in the glass block, for which purpose this light is reflected at at least one reflection surface of the glass block.

The coupling unit according to the invention has the advantage over the previously known models that it does not comprise a number of individual parts which have to be put together but a single glass block. This may consist for example of simple quartz glass.

To make the glass block usable as a light guide, the glass structure of a monolithic glass block is changed along individual straight lines by intensive laser irradiation in such a way that the glass has a higher refractive index there. These lines then form the core of integrated light guiding channels. Like an individual optical fiber, such a light guiding channel has an optically denser core and an optically thinner cladding. If the glass block has a number of light guiding channels, a number of light signals can be guided in parallel and deflected within a single component.

Since the inducing process can be precisely carried out for example by laser pulses in the femtosecond range (for example a Ti:Al₂O₃ laser pulse), there is the possibility of producing the coupling element automatically.

The output plane of the coupling element can be varied in a simple manner by a different form of the glass block. Consequently, there is no longer a confinement to a fixed output plane, as in the prior art.

A particularly preferred embodiment is distinguished by the fact that the monolithic glass block has just one polished reflection surface, which is inclined by 45° with respect to the perpendicular to the plane of incidence. The reflection surface may be mirror-coated, in order possibly to improve the degree of reflection in this way. By such an inclined surface, the signals emitted for example vertically by a VCSEL laser are deflected by 90° into the horizontal, where they are deflected into continuing light guides.

Another advantageous embodiment provides for an existing gap between the monolithic glass block and the optoelectronic converter to be closed. This may take place for example by the gap being sealed by a sealing compound (for example silicone). This has the practical benefit that the light source is protected from damage and the signal path is protected from contaminants. Such sealing may also be provided between the glass block and optical waveguides kept at a distance from it.

A further embodiment constitutes that a lens or a lens array is applied to the end of the coupling unit opposite the optical waveguide. This lens increases the efficiency of coupling into the fiber and at the same time makes it possible to satisfy the “Restricted Mode Launch” according to IEEE 802 (the gigabit Ethernet standard).

This lens may be formed in very different ways. In particular, on the one hand it may consist of a planar material with refractive index gradients (a so-called GRIN: GRadient INdex), for example a glass cylinder with a radially variable refractive index.

A second possibility is in particular that the lens is injection-molded on from plastic (specifically PMMA, polymethylacrylate, Plexiglas with acrylic).

A further possibility is that the lens is applied directly to the end of the coupling unit, in particular by means of a lithography technique. For example, Fresnel lenses can be introduced into the end of the coupling unit opposite the optical waveguide by various lithographic possibilities.

An array of optoelectronic converters which is optically coupled by means of a monolithic glass block with an array of light guiding channels to an array of optical waveguides is preferably provided. A number of converters and optical waveguides are in this case coupled to one another by a glass block. The array of optoelectronic converters is in this case preferably an array of VCSEL lasers.

In a preferred configuration, the at least one optical waveguide is arranged in a plug receptacle, to which an optical plug can be coupled. This permits direct coupling to optical waveguides of an optical cable.

The optoelectronic converter is arranged for example on a planar substrate together with further electrical components. Contacting of the converters and other components takes place by means of metallizations of the planar substrate.

Another advantageous embodiment provides that the light signals are only guided in a light guiding channel of the glass block before or after the deflection. In other words, the integrated light guiding channel runs exclusively between an outer surface of the glass block and the reflection surface. A light signal passing through the coupling unit is consequently guided by a light guiding channel only along one path within the glass block; the light signal takes a second path unguided through the glass block. Advantageously, this unguided length of path is as short as possible, in order to minimize divergences.

### BRIEF DESCRIPTION OF THE DRAWINGS

The invention is explained below on the basis of several exemplary embodiments with reference to the figures of the drawing, in which:

FIG. 1 shows a monolithic coupling unit in a schematic exploded representation;

FIG. 2 shows a sectional representation of a coupling unit which has a lens array and a silicone compound;

FIG. 3 schematically shows an arrangement of an optical assembly with an array of transmitting components, an array of optical waveguides and a monolithic coupling unit;

FIG. 4A schematically shows a coupling unit with a number of light guiding channels in a plan view;

FIG. 4B shows the coupling unit of FIG. 4A in side view; and

FIG. 5 schematically shows a coupling unit with a light guiding channel on only one side of a reflection surface in side view.

### DESCRIPTION OF PREFERRED EXEMPLARY EMBODIMENTS

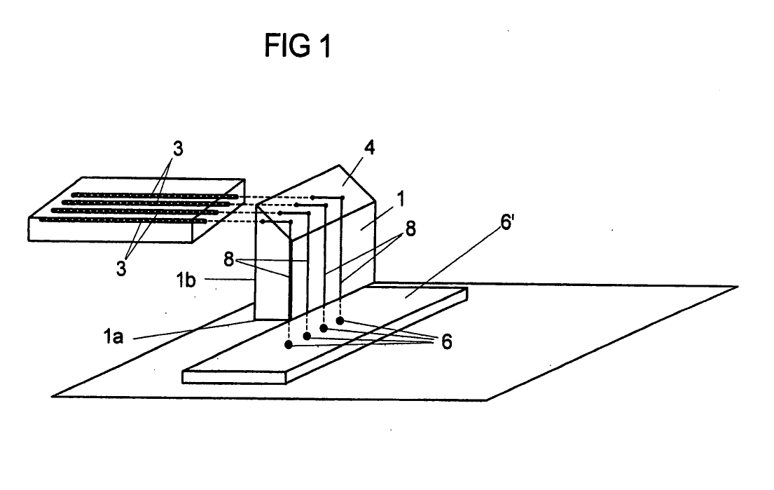

FIG. 1 shows a coupling unit, which comprises a monolithic glass block 1. Integrated into the glass block 1 are light guiding channels 8, which have a higher refractive index than the remaining glass block 1. The light guiding channels 8 are arranged in the form of a one-dimensional array. The glass block 1 also has on its outer side an obliquely running reflection surface 4. Otherwise, the glass block 1 has the form of a right-parellelepiped.

The reflection surface 4 may be additionally mirror-coated. Furthermore, the reflection surface does not necessarily have to be formed on an outer surface of the glass block 1; it may similarly run on an inner boundary surface.

The glass block 1 is assigned a multiplicity of optoelectrical converters 6, which are arranged in a one-dimensional array 6′. They are preferably vertically emitting lasers. In principle, however, edge-emitting lasers with a deflecting optical system or other converters may also be used.

The converters 6 respectively emit light signals, which are coupled into the light guiding channels 8 integrated in the glass block 1. The light signals are reflected at the reflection surface 4 and deflected within the light guiding channels 8. After passing through the coupling unit, the light signals leave the coupling unit. They then pass through a small freely radiating region and are then coupled into assigned optical waveguides 3. The optical waveguides 3 may alternatively also directly adjoin the glass block 1.

Instead of the optical waveguides, here there may also be other electrooptical or optical components. Furthermore, the light signals may of course also pass through the monolithic glass block 1 in the opposite direction. The optoelectronic converters 6 would then be formed as receiving components such as photodiodes.

It is pointed out that, in the exemplary embodiment of FIG. 1, the outer surface 1a of the glass block 1, which represents the light-entering surface, and the outer surface 1b of the glass block, which represents the light-exiting surface, run at an angle of 90° in relation to each other. In principle, an angle deviating from this may also be provided, for instance if the optical waveguides are coupled in an oblique arrangement. For this case, the reflection surface 4 would run at an angle other than 45°.

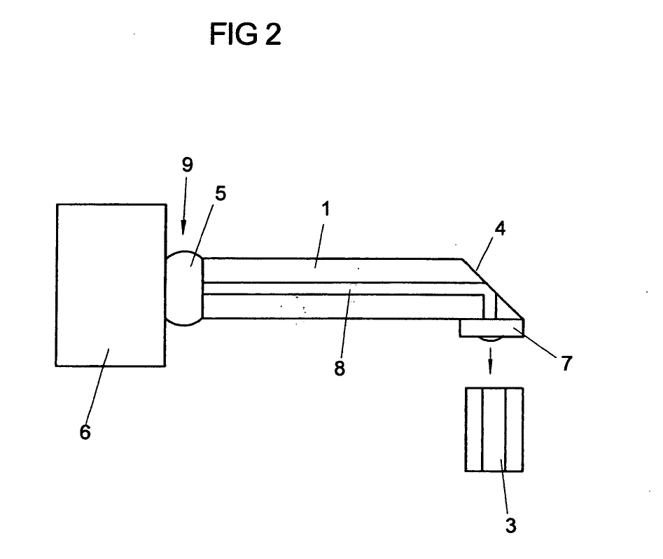

FIG. 2 shows an exemplary embodiment of the arrangement of FIG. 1 in a sectional view. Formed between the optoelectronic converter 6 and the monolithic glass block 1 is a sealing compound 5 (for example silicone) for sealing the gap 9. The light signals pass through the sealing compound 5 before they couple into the light guiding channel 8. The sealing compound protects the optical path and additionally the optoelectronic converters 6 from damage.

The exemplary embodiment of FIG. 2 also shows a lens array 7, which is placed on, or formed in, the glass block 1 in a region from which the light signals reflected at the surface 4 emerge from the glass block or which lies opposite the optical waveguides 3. The lens array provides a greater efficiency of coupling into the optical waveguides 3.

As an alternative or in addition, a sealing compound may also be provided between the light-exiting side of the glass block and the optical waveguides 3 and possibly also enclose a lens array 7.

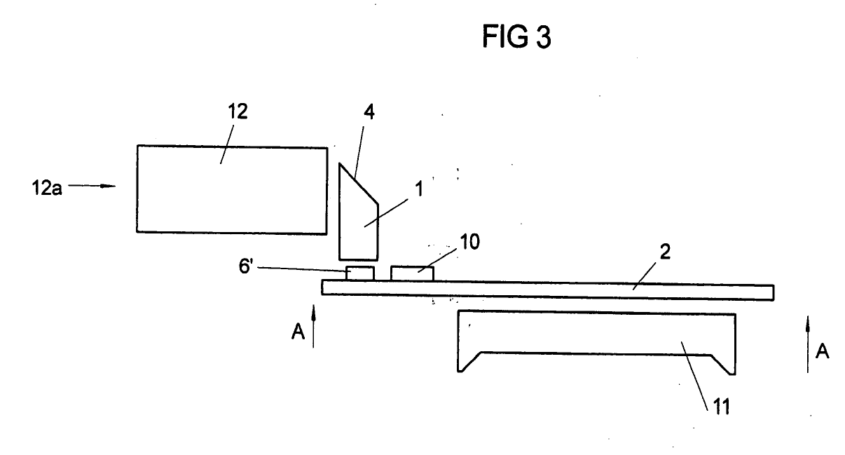

FIG. 3 shows an exemplary embodiment of a complete arrangement for the transmission of light signals. An array 6′ of VCSEL lasers is provided as optoelectronic converters (corresponding to the optoelectronic converters 6 of FIG. 1) on a planar substrate 2. The converter array 6′ is assigned a driver module 10. The electrical contacting of the array 6′ and driver module 10 takes place by means of electrical lines (not shown) on the substrate 2. The converter array 6′ is assigned a glass block 1, as described on the basis of the previous figures. In a plug receptacle 12 assigned to the glass block there are a multiplicity of optical waveguides corresponding to the optical waveguides 3 of FIG. 1. At the same time, the plug receptacle 12 has an optical port or receiving region 12a, which serves for receiving an optical plug (not shown). In this way, the light signals coupled in can be passed on to an optical cable.

Preferably, the glass block 1 is firstly adjusted with respect to the converter array 6′, sealing with a sealing material possibly being performed in the way described above. The entire substrate is subsequently brought into a position by means of a schematically represented lifting device 11 in the direction of the arrows A such that optimal coupling of the light coupled out from the glass block 1 to the optical waveguides of the plug receptacle 12 takes place. In the desired position, the plug receptacle is then positioned with respect to the printed circuit board. As an alternative to the adjustment, a glass block of a suitable length is used.

The function of the arrangement is as described with reference to the previous figures. In this case, a receiving array may of course also be used instead of a converter array.

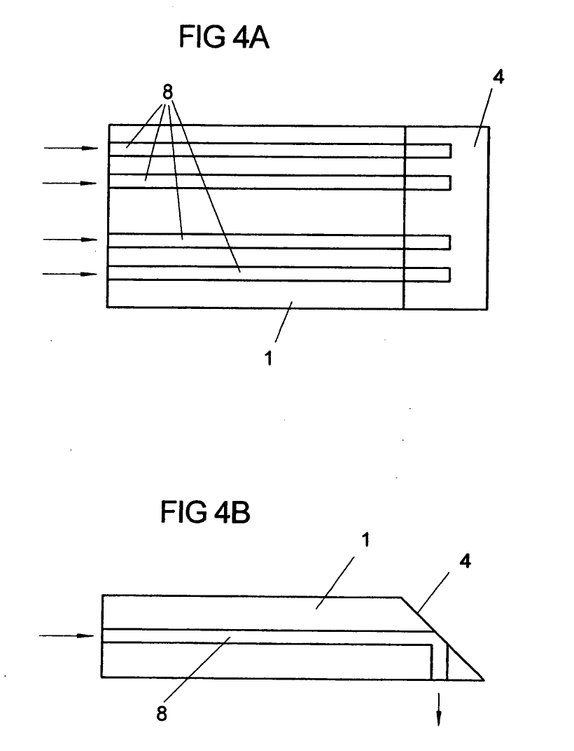

FIGS. 4A and 4B show in plan view and in lateral section the light guiding channels 8 which are integrated into a glass block 1 and run parallel to one another. It can be clearly seen that the light guiding channels 8 are bent away at right angles at the reflection surface 4.

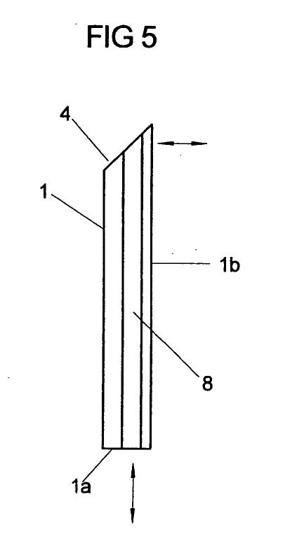

FIG. 5 shows in side view a coupling unit comprising a thin monolithic glass block 1, in which an integrated light guiding channel 8 is formed only between the first outer surface 1a and the reflection surface 4. On the other hand, the coupling unit has no integrated light guiding channel between the reflection surface 4 and the second outer surface 1b. The light path or the distance between the reflection surface 4 and the second outer surface 1b is advantageously short, to produce the least possible divergences in a light signal transported through the coupling unit. This configuration is distinguished by allowing simple and inexpensive production, since only light guiding channels running linearly in one direction have to be formed in the glass block. The glass block is, for example, a glass plate with a beveled reflection surface.

We claim:

1. An optical coupling unit for coupling at least one optoelectronic converter to an assigned optical waveguide,
wherein
the coupling unit comprises a monolithic glass block in which at least one integrated light guiding channel produced by variation of the refractive index, and least one reflection surface at which light signals passing along the at least one integrated light guiding channel are deflected.

2. The coupling unit as claimed in claim 1, wherein the monolithic glass block has a reflection surface, which deflects the light signals by an angle of 90°.

3. The coupling unit as claimed in claim 1, wherein the reflection surface is mirror-coated.

4. The coupling unit as claimed in claim 1, wherein the monolithic glass block consists of quartz glass.

5. The coupling unit as claimed in claim 1, wherein the integrated light guiding channelis produced in the monolithic glass block by irradiation of ultrashort laser pulses.

6. The coupling unit as claimed in claim 1, wherein the light signals are only guided in a light guiding channel before or after the deflection.

7. The coupling unit as claimed in claim 1, wherein the monolithic glass block comprises one of a one-dimensional array and a two-dimensional array of light guiding channels.

8. The coupling unit as claimed in claim 1, wherein at least one lens is provided on at least one side of the coupling unit.

9. The coupling unit as claimed in claim 7, wherein at least one lens array, which shapes the light entering or leaving the light guiding channels, is provided.

10. The coupling unit as claimed in claim 8, wherein said at least one lens consists of a planar material with refractive index gradients.

11. The coupling unit as claimed in claim 8, wherein said at least one lens consists of plastic injection-molded onto the glass block.

12. The coupling unit as claimed in claim 8, wherein said at least one lens is applied by means of a lithography technique.

13. An optical arrangement for transferring light signals from at least one optoelectronic converterto an assigned optical waveguide, and from the optical waveguide to a coupling unit, wherein the coupling unit comprises a monolithic glass block including a first region having a first refractive index and at least one integrated light guiding channel extending through the first region and having a second refractive index, the glass block also having at least one reflection surface arranged such that light signals passing along the at least one integrated light guiding channel are deflected,
wherein the optoelectronic converter and the assigned optical waveguide are optically coupled to each other by the at least one light guiding channel of the coupling unit.

14. The arrangement as claimed in claim 13, wherein between the optoelectronic converter and the monolithic glass block there is a gap, and wherein the gap is sealed by a sealing material.

15. The arrangement as claimed in claim 13, wherein between at least one optical waveguide and the monolithic glass block there is a gap, and wherein the gap is sealed by a sealing material.

16. The arrangement as claimed in claim 13, wherein an array of optoelectronic converters is optically coupled by a plurality of the light guiding channels formed in the monolithic glass block to an array of optical waveguides.

17. The arrangement as claimed in claim 16, wherein the array of optoelectronic converters is an array of VCSEL lasers.

18. The arrangement as claimed in claim 13, wherein the at least one optical waveguide is arranged in a plug receptacle to which an optical plug can be coupled.

19. The arrangement as claimed in claim 13, wherein the optoelectronic converter is arranged on a planar substrate together with further electrical components.

20. An optical coupling unit for coupling an otoelectronic converter to an optical waveguide, the optical coupling unit comprising:
a monolithic glass block having a first refractive index, the monolithic glass block defining a first surface for receiving light signals from the optoelectronic converter, a second surface for passing the light signals to the assigned optical waveguide,
wherein the monolithic glass block further defines a light guiding channel extending from the first surface to the second surface through the monolithic glass block, and
wherein the light guiding channel is formed by altering a portion of the monolithic glass block such that the light guiding channel has a second refractive index that is greater than the first refractive index of unaltered regions of the monolithic glass block that surround the light guiding channel.
